(19) United States
(12) Patent Application Publication
(10) Pub. No.: US 2016/0305027 A1
(43) Pub. Date: Oct. 20, 2016

(54) FLAT PRODUCT WITH A COATING SYSTEM AND PROCESS FOR COATING SAID FLAT PRODUCT

(71) Applicants: THYSSENKRUPP STEEL EUROPE AG, Duisburg (DE); THYSSENKRUPP AG, Essen (DE)

(72) Inventors: Matthias Kimpel, Schwelm (DE); Thomas Lostak, Duisburg (DE)

(73) Assignees: ThyssenKrupp Steel Europe AG, Duisburg (DE); ThyssenKrupp AG, Essen (DE)

(21) Appl. No.: 15/102,223

(22) PCT Filed: Dec. 9, 2014
(86) PCT No.: PCT/EP2014/076987

§ 371 Date: Jun. 6, 2016

(30) Foreign Application Priority Data
Dec. 9, 2013 (DE) 10 2013 113 731.8

(51) Int. Cl. C23C 22/34; B05D 3/04; B05D 7/14; C23C 26/00; B05D 7/24

(52) U.S. Cl. CPC C23C 22/34; C23C 26/00; B05D 7/24; B05D 7/14; B05D 3/0466; B05D 7/54

(57) ABSTRACT

Flat products may have a core layer comprising a metal material and a coating system that is applied to the core layer. The coating system may comprise a conversion layer with inorganic constituents that enhance adhesion of an outer polymer layer to the core layer. To provide an environmentally-friendly coating system that also offers optimum conditions for adhesion of the outer polymer layer, the coating system may comprise an adhesion promoter component that includes an organosilane and shields the adhesion-promoting inorganic constituents of the conversion layer relative to the surroundings. The present disclosure likewise provides processes for producing the flat products.

The invention relates to a flat product which has a core layer consisting of a metal material and has a coating system which is applied to the core layer and which comprises a conversion layer made of inorganic constituents which enhance the adhesion to the core layer of an outer layer which comprises at least one polymer and is intended for application to the flat product. Flat products of this kind are typically strips, sheets, billets, or other flat products, which are produced by hot or cold rolling of steel, aluminum or other metal materials and whose width is in each case significantly greater than their thickness.

The invention further relates to a process for producing a flat product of this kind.

Organic coatings are applied in particular to flat steel products in order to create optimum conditions for the adhesion of a paint, which in bodywork construction is typically applied as one of the last operations to the component produced by forming from the flat product in question.

In practice for this purpose the flat product in question is subjected to what is called “phosphating”, where an aqueous phosphate solution is applied to the flat steel product and reacts with the particular metal substrate to form what is called a “conversion layer” of firmly adhering metal phosphates. This phosphating is regularly applied both with flat steel products that receive no further coating and with flat steel products that are coated with a metallic anticorrosion layer. Nevertheless, flat products produced on the basis of aluminum, for example, are also suitable for phosphating. The phosphate layer obtained in each case adheres very well to the particular substrate and, as a result of the microporous or microcapillary layer structure, permits effective anchorage of subsequent coatings. Another effect important for practical purposes is that the phosphate layers formed in phosphating present a high electrical resistance. The layer thicknesses obtained by phosphating range from several hundred nanometers up to two micrometers.

Thinner conversion layers can be generated in particular by chromating, for example. A disadvantage of the processes that enable thin layers, however, is that their chemical basis is commonly regarded as being toxic or at least critical from an environmental standpoint.

Conventional conversion layers (preferably phosphate-based) and modern alternatives repeatedly show deficiencies in temporary and permanent adhesion on a variety of metallic substrates. The reason for this lies frequently in the in part layerlike construction of such conversion layers (fracture under certain circumstances within the layer, and/or loss of adhesion to the polymeric coating above).

From the article “Formation and characterization of Fe3+—/Cu2+-modified zirconiumoxide conversion layers on zinc alloy coated steel sheets” by T. Lostak et al., published under URL “www.elsevier.com/locate/elec tacta” in Electrochimica Acta 112 (2013) 14-23, it is known that conversion layers which comprise zirconium oxides as the adhesion-promoting inorganic constituents are unobjectionable from the standpoint of environmental protection and are particularly suitable for coating flat steel products. At the same time, the Zr conversion layers have an optimally high electrical resistance and form an effective protection against corrosion of the particular substrate coated with the conversion layer. According to the article, the Zr conversion layers can be produced on the flat metal product in question by first cleaning the flat product with an alkaline cleaner, then rinsing it with demineralized water, and subsequently drying it in a hot stream of air. To the flat product thus prepared, at this point, an aqueous solution which comprises 0.1 mol of Cu(NO₃)₂•3H₂O (HZF+Cu) or Fe(NO₃)₃Φ9H₂O(HZF+Fe) and also hexafluorozirconic acid (H2ZrF6) (“HZF”) in a concentration of 1 mol/l. The pH of the conversion solution is adjusted to 4 by addition of 10 wt % of ammonium bicarbonate (NH₄HCO₃, 10 wt %). The particular metal sheet samples investigated were immersed at a temperature of 20° C. into the solution thus composed. On conclusion of the immersing operation, the samples were rinsed with high-purity water and then dried in a stream of nitrogen gas.

Practical trials show that coating systems applied in the above way do, admittedly, allow initially optimal adhesion of a polymer layer applied to this coating system. However, investigations on samples coated accordingly reveal that the coatings thus applied do not bind with durable moisture stability to the applied conversion layers. The reason for this phenomenon is considered to be that the inorganic constituents of the coating are able to attach only via secondary interactions of the hydroxyl groups in the conversion layer. If, following activation of the defect region, the electrolyte penetrates between the conversion layer/polymer interface, the adhesion is lost, and a thin layer of electrolyte is formed.

Against the background of the prior art as elucidated above, the object of the invention was to provide a flat product wherein durably secure adhesion of a polymer layer applied to a coating system is ensured by means of this coating system, which is of improved adhesion, is environmentally unobjectionable, and is optimized in terms of layer development and minimized layer thickness, and does so even in the event that a metallic protective layer, providing protection from corrosion, is additionally applied to the core layer of the flat product. The polymer layer may be, for example, a paint system or a layer of adhesive, via which a component is adhered to the flat product in question, or via which the flat product is joined to another flat product, having the same or different properties, in the manner of a sandwich, to form a composite material.

The intention furthermore was to specify a process for producing a flat product of this kind.

In relation to the flat product, the invention has achieved this object by a flat product of this kind possessing the features specified in claim 1.

A process which achieves the object stated above is specified in claim 7.

Advantageous refinements of the invention are specified in the dependent claims and are elucidated below in detail, as is the general concept of the invention.

A flat product according to the invention, accordingly, in agreement with the prior art elucidated at the outset, has a core layer consisting of a metal material and has a coating system which is applied to the core layer. This coating system comprises a conversion layer with inorganic constituents which enhance the adhesion to the core layer of an outer layer which comprises at least one polymer and is intended for application to the flat product.

In accordance with the invention, then, the coating system comprises an adhesion promoter component which consists of an organosilane and which shields the adhesion-promoting inorganic constituents of the conversion layer relative to the surroundings.

In line with the same concept of invention, a process according to the invention with which a flat product which has a core layer made of a metal material and optionally has a metallic protective coating which is formed on the core layer and provides protection from corrosion can be coated with a coating system which comprises a conversion layer having inorganic constituents, which enhances the adhesion to the core layer of an outer layer which comprises at least one polymer and is intended for subsequent application, comprises the following worksteps:
a) cleaning of the flat product with an alkaline cleaner;
b) rinsing the cleaned flat product with demineralized water;
c) drying the rinsed flat product;
d) applying a conversion solution which comprises in aqueous solution a Zr compound or Ti compound which dissociates into zirconium- or titanium-fluoro complexes, to the flat product to form a conversion layer, where
   d1) according to a first alternative of the conversion solution, an organosilane which comprises an epoxy group and is water-soluble is additionally added as adhesion promoter, or
   d2) according to a second alternative, the conversion solution is first applied to the flat product, after which the flat product is rinsed with demineralized water or service water, and then an aqueous solution is applied of an organosilane which comprises an epoxy group and which serves as adhesion promoter;
e) drying the flat product.

The starting point for the invention here is the finding that the key mechanisms for disbonding of polymeric coatings (e.g., paint, adhesive) from various metallic substrates are cathodic in nature. This means that the local reduction of oxygen leads to bond rupture and hence to the disbonding of the polymer even when the flat product coated with the polymer layer has been provided, between the polymer layer and its core layer, with a coating system which comprises inorganic constituents which adhere firmly to the flat product, for the purpose of improving the adhesion of the polymer coating.

The inorganic conversion layers applied in accordance with the invention also consist in general substantially completely of at least one metal oxide, namely Zr oxide or Ti oxide, which inhibits electron transfer at the metal/polymer interface and therefore effectively prevents reduction of oxygen. With a band gap of at least 3 eV (E_{g}>3 eV), more particularly at least 4 eV (E_{g}>4 eV), the Zr or Ti oxides mandated in accordance with the invention act as an electrical insulator.

As a result of the presence of a suitable adhesion promoter, in accordance with the invention, in the coating system applied to the core layer, a multilayer system is produced which, using constituents that are unobjectionable from the viewpoint of environmental protection, reaches at least the same level as conventional systems of this kind.

In the case of a coating system according to the invention, electron transfer from the metallic substrate into the electrolyte is prevented by the isolation of the inorganic, adhesion-promoting constituents of the conversion layer from the surroundings by means of the organosilane component provided in accordance with the invention. Consequently, a polymer layer applied to a flat metallic product provided with a coating according to the invention can be attached in a moisture-stable way to the conversion layer.

In the manner according to the invention, ultra thin layer systems can be constructed here on the flat product in question. Accordingly, in the case of a coating system designed in accordance with the invention, the conversion layer and the adhesion promoter together generally occupy a total thickness of only 20-200 nm, with typical overall thicknesses lying in the 20-50 nm range.

The invention is particularly suitable for flat products where the core layer consists of a steel material. In a manner known per se, this core layer may have been coated with a metallic protective layer which protects the core layer against corrosive attack. In that case, the coating system which is in accordance with the invention is applied to the metallic protective layer and permanently ensures optimum adhesion of a polymer coating (paint system) applied to the flat product to the metallic protective layer and consequently to the core layer of the flat product. The metallic protective layer here may comprise any coatings alloyed on the basis of Zn, Al, Sn or Mg. It is also possible to construct a coating according to the invention directly from highly alloyed stainless steels. The same is true of hot-rolled or cold-rolled steel strips or steel sheets made from low-alloy or unalloyed steels, even when they have not been coated with an anticorrosion layer.

Particularly in relation to minimized environmental burden, it has emerged as being optimum for the conversion layer formed in accordance with the invention to comprise zirconium oxide or titanium oxide as inorganic constituent enhancing the adhesion of the polymer layer to the core layer.

Suitable for the alkaline cleaning which is carried out ahead of the conversion treatment are conventional cleaners of the kind available on the market for this purpose. After cleaning has taken place, the cleaned flat product is rinsed with demineralized water to prevent contamination of the subsequent cycle of coating operations with the cleaner. This is followed by a first drying of the flat product.

With a coating system formed in accordance with the invention, the conversion layer and the adhesion promoter component may have been applied in such a way that the conversion layer lies on the core layer, or on the anticorrosion layer which is present on said core layer, and the conversion layer is shielded by an adhesion promoter layer formed from the organosilane. In order to realize a layer construction of this kind, the conversion solution, comprising in aqueous solution the respective metal oxide-forming component, is first applied to the particular metallic substrate and, after a rinsing procedure, in a second workstep, a further aqueous solution is applied which comprises the organosilane component (variant d2) of workstep d).

If, in contrast, individual metal oxide particles of the conversion layer are to be imbedded into the adhesion promoter component, this can be accomplished by—as indicated in the first alternative d1) of workstep d) of the process according to the invention—the conversion solution that is applied to the core layer or to the anticorrosion layer present thereon comprising not only a Zr or Ti compound which dissociates into zirconium-fluoro or titanium-fluoro complexes, but also, at the same time, an organosilane component in aqueous solution.

The Zr compounds to be added to the conversion solution in accordance with the invention, and dissociating into Zr-fluoro complexes in aqueous solution, include zirconium salts, more particularly hexafluorozirconium salt or alkali metal zirconate, alkaline earth metal zirconate, and ammonium zirconate, or, generally, salts of hexafluorozirconic acid. Examples of such compounds include dipotassium hexafluorozirconate, disodium hexafluorozirconate, ammonium hexafluorozirconate, magnesium hexafluorozirconate, dilithium hexafluorozirconate.

In the case where Ti compounds are to be added as oxide formers to the conversion solution, the Ti compounds contemplated for this purpose are those which in aqueous solution undergo dissociation into Ti-fluoro complexes. They include titanium salts, more particularly hexafluorotitanium salt or alkali metal titanate, alkaline earth metal titanate, and ammonium titanate, or, generally, salts of hexafluorotitanic acid. Examples of such compounds include dipotassium hexafluorotitanate, disodium hexafluorotitanate, ammonium hexafluorotitanate, magnesium hexafluorotitanate, dilithium hexafluorotitanate.

Practical trials have shown that the Zr or Ti compound in question ought to be present in a concentration of 10⁻⁵-10⁻¹ mol/l in the conversion solution, with concentrations of 2×10⁻⁵-10⁻² mol/l, more particularly 10⁻⁵-2×10⁻³ mol/l, having emerged as being particularly in tune with practice.

The formation of an optimum conversion layer is promoted by maintaining the conversion solution at 20-35° during application. If the process is to be accelerated, the temperature of the conversion solution may also be raised to up to 95° C.

The formation of the conversion layer provided in accordance with the invention may be supported and accelerated, moreover, if the conversion solution comprises amounts of a layer formation accelerator, such as water-soluble silver salt, copper salt or iron salt. All water-soluble compounds which release metal cations are suitable. A condition for an increase in the layer formation kinetics here is that the standard electropotential of the metal cation released is more strongly positive than the standard electropotential of the substrate to be coated (E⁰_{Me}>E⁰_{Substrate}). Contemplated accordingly are Ag(I) salts, Cu(II) salts or Fe(III) salts. Specific examples include silver nitrate (Ag(NO₃)) or copper nitrate (Cu(NO₃)₂) and also silver sulfate (Ag₂SO₄) or copper sulfate (CuSO₄).

In order to ensure adequate activity, the conversion solution ought to include 10⁻⁶-10⁻¹ mol/l of the layer formation accelerator. In practical experiments, concentrations of 10⁻⁵-10⁻² mol/l, more particularly 2×10⁻⁵-10⁻³ mol/l, have proven particularly appropriate.

Irrespective of which of the alternatives d1), d2) are adopted in workstep d), the respective coating is applied preferably by immersion into a bath which is formed from the conversion solution and is conditioned at room temperature, the residence time in the bath being typically 10-300 seconds. In the case of alternative d2), the flat product is immersed correspondingly, after application of the conversion layer, over 10-300 s into a bath formed from the aqueous solution of the organosilane and likewise conditioned at room temperature.

In principle it is possible, as adhesion promoters for the purposes of the invention, to use all organosilanes which contain epoxy groups and are water-soluble. They typically have 1 to 40, more particularly 1 to 30, carbon atoms, with it generally being possible in practice to use organosilanes which possess 5-20 carbon atoms. The organosilanes in question include alkoxysilanes, more particularly methoxysilanes or ethoxysilanes. Specific examples are [3-2(2,3-epoxypropoxy)propyl]trimethoxysilane, [3-2(2,3-epoxypropoxy)propyl]triethoxysilane, [3-2(2,3-epoxypropoxy)propyl]methyldiethoxysilane, [3-2(2,3 -epoxypropoxy)propyl]methyldimethoxysilane, [3-2(2,3 -epoxypropoxy)propyl]methylethoxysilane, and these compounds can each be employed alone or in combination.

The amounts of the organosilanes in the conversion solution ought to be in the range of 0.45-5 wt %, more particularly 0.6-3 wt %, with amounts of 0.8-1.5 wt % having proven to be particularly in tune with practice.

The various drying procedures can each be carried out under a stream of nitrogen, if reaction with the ambient oxygen is to be prevented, or else drying may take place under a stream of air if this is not critical. In order to accelerate drying, the drying temperature may be raised to 40-150° C., more particularly to 40-120° C. or 80-100° C. Alternatively or additionally to drying in a stream of air, sublimation drying and/or drying assisted by IR, NIR or UV radiation may take place. Practical drying times for drying of the layers applied in workstep d) are in the region of 60-100 s, more particularly up to 90 s. In this time, the covalent attachment of the organosilanes to the respective surface of the core layer or to the metallic protective layer present thereon is reliably achieved within the temperature window mandated by the invention.

The invention is elucidated in more detail below with reference to working examples. In the figures, schematically in each case:

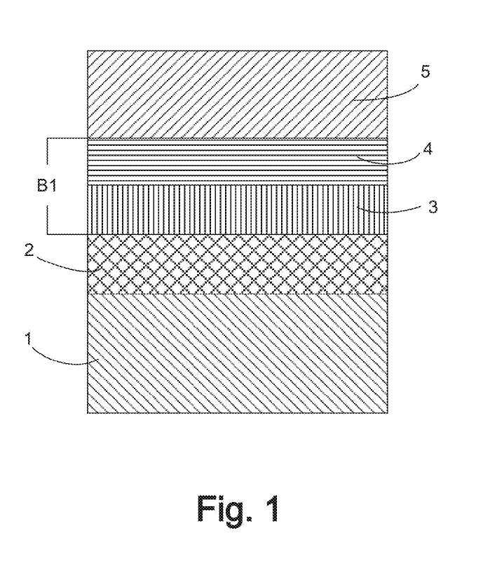

FIG. 1 shows a layer construction produced in two stages;

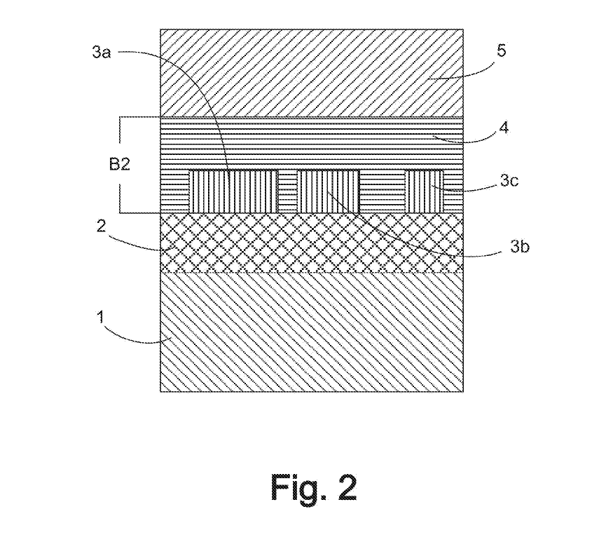

FIG. 2 shows a layer construction produced in one stage;

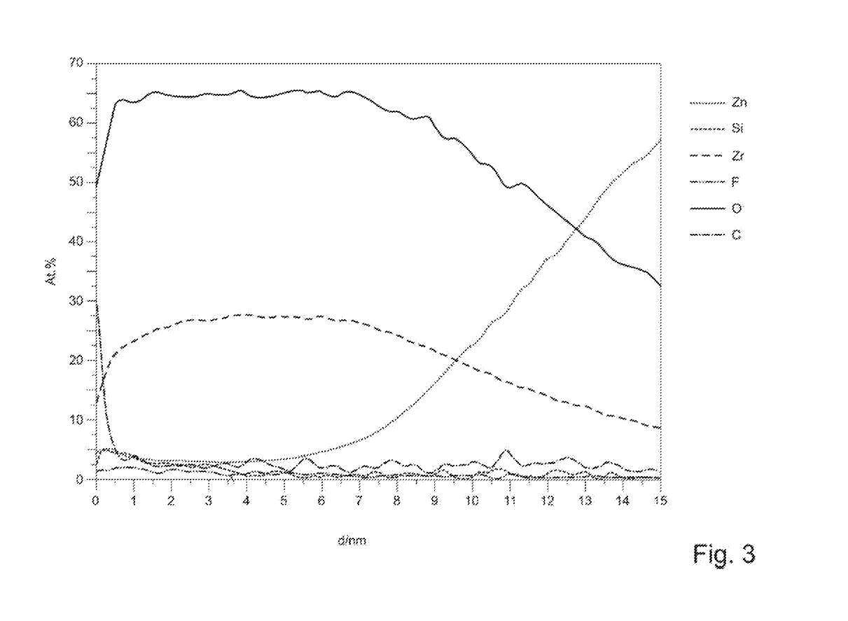

FIG. 3 shows a diagram with the result of an XPS on a sample formed in accordance with FIG. 2;

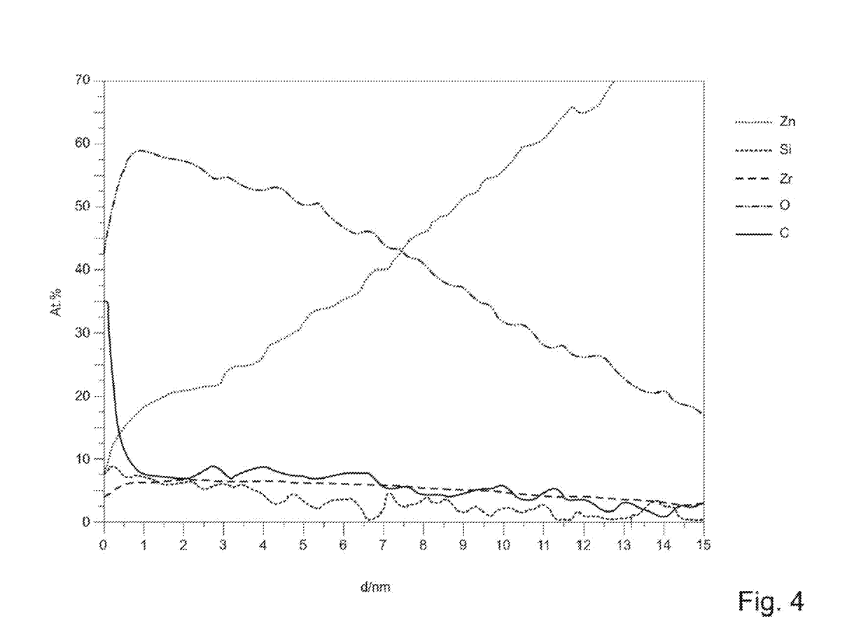

FIG. 4 shows a diagram with the result of an XPS on a sample formed in accordance with FIG. 1;

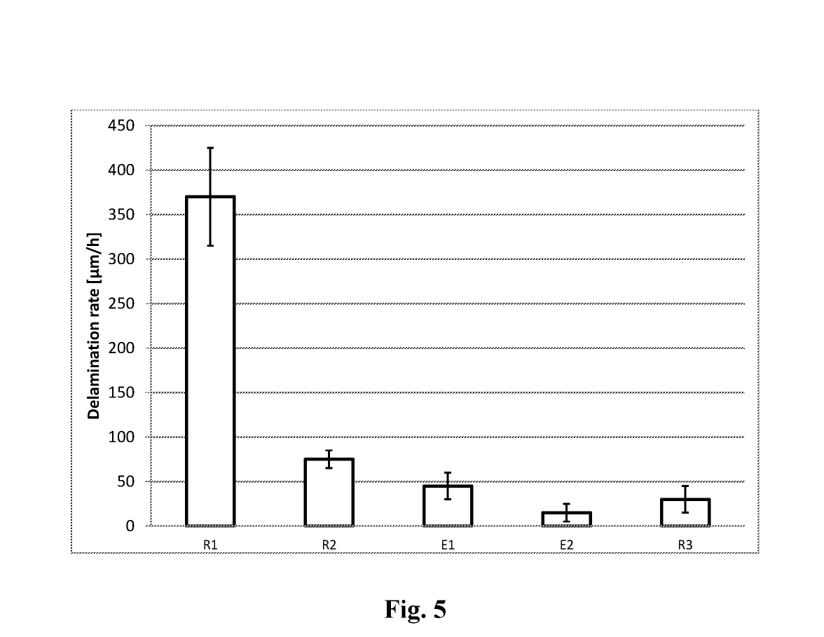

FIG. 5 shows a diagram representing the delamination rates determined for different reference samples and inventive samples E1, E2.

Depicted in FIG. 1, schematically and not to scale, is a layer construction produced in two stages on a flat steel product in accordance with alternative d2) of claim 7. The core layer 1 here, which consists of a steel material, is coated with a Zn-based protective layer 2 which protects the core layer from corrosion. Applied atop the protective layer is a conversion layer 3, whose adhesion-promoting component is ZrO₂. The conversion layer 3, which adheres firmly to the protective layer 2, is shielded on its side facing away from the core layer 1 by an adhesion promoter layer 4 which consists of an organosilane. The conversion layer 3 and the adhesion promoter layer 4 together form a coating system B1, which ensures a permanently firm adhesion of a polymer layer 5 applied to the side of the adhesion promoter layer 4 that is facing away from the conversion layer 3. The thickness of the coating system B1 in this case is 25-50 nm. In the case of the example described here, the polymer layer is a paint layer. As polymer layer, however, it is also possible for a layer of adhesive or the like to be applied.

The layer construction depicted in FIG. 2, in contrast, has been produced in accordance with alternative d1) of claim 7, in one stage. For this purpose, a conversion solution has been applied to the protective layer 2 which is present on the core layer 1 of the flat product for coating, comprising both the oxide-forming Zr component and the organosilane component in aqueous solution. As a consequence of the joint, simultaneous application, on the side of the protective layer 2 facing away from the core layer 1, individual islands 3a, 3b, 3c of ZrO₂ have formed, adhering firmly to the protective layer 2, which are shielded by the organosil component acting as adhesion promoter. Here as well, the layer thickness of the coating system B2 formed from the conversion solution is 20-50 nm. The coating system B2 produced in accordance with alternative d1) also ensures a permanently firm adhesion of the polymer layer (paint layer or layer of adhesive) 6 applied to the side of the coating system B2 which is facing away from the core layer 1.

The layer differences between the coatings produced according to alternative d1) and d2) were characterizable by XPS and are in FIGS. 3 (alternative d1)) and 4 (alternative d2)). In the diagrams depicted there, the profiles of the amounts of the constituents indicated in the legend to the respective diagram are plotted against the respective thickness B1, B2, specifically starting from the surface (at “0”) of the coating system in the direction of the core layer 1.

Having been determined in FIG. 5, in a further diagram, are the delamination rates ascertained for various reference samples R1, R2, R3 and inventive samples E1, E2, said rates describing the detachment characteristics of a polymer layer applied to the surface in question. Reference sample R1 here is a steel sheet which has simply been given an alkaline clean that is, however, otherwise untreated. For reference sample R2, a conversion layer with Zr oxide as inorganic, adhesion-promoting constituent has merely been applied in a known way to the steel sheet. Reference sample R3, lastly, is a steel sheet phosphated in a known way.

Inventive sample E1 is a steel sheet coated in the above manner in accordance with alternative d1), whereas inventive sample E2 has been produced in accordance with alternative d2) likewise elucidated above.

A minimized detachment rate corresponds to an optimized adhesion. It is therefore apparent that the inventive samples have detachment characteristics which are consistently better than the detachment characteristics of reference samples R1 and R2. The same is true for the inventive sample E1 in comparison with reference sample R3, and the detachment rate ascertained for the other inventive sample, E1, also comes close to that of reference sample R3.

In further experiments, a cold-rolled flat steel product whose core layer consisted of a deep-drawn steel with sufficient forming properties that is determined for typical automotive application, such as the production of bodywork components for the outer skin of a vehicle, and whose core layer has been coated on either side in a hot-dip galvanizing process with an anticorrosion layer of zinc approximately 10 μm thick, was coated in the manner according to the invention after having undergone temper rolling.

For this purpose, the flat steel product was first exposed to preliminary degreasing of an alkaline cleaner and was neutralized by water rinsing. The cleaned surface was subsequently dried in a heated stream of air.

Subsequently, a primarily aqueous formulation was applied to the flat steel product, in order to provide the flat steel product with a coating system which has a surface condition-converting effect.

The predominantly aqueous formulation applied was characterized by the presence of Zr (resulting from an H₂ZrF₆ content of 0.001 mol/l to 0.01 mol/l of the conversion solution), of organosilane in amounts of 1-1.5 wt % (resulting from the combined, epoxy group-containing epoxy silanes), and of Fe in amounts of up to 0.1 mol/l (resulting from 0.005 . . . 0.01 mol/l of a water-soluble iron salt in the conversion solution). The coating system was adjusted to a pH range of 4+/−0.5, with the pH being typically 4-4.2. This pH range was stabilized by adding up to 10 wt % of ammonium bicarbonate to the aqueous formulation.

The following alternative methods were trialed for the application of the aqueous formulation:

In the case of the first variant, the aqueous formulation was dried in an immersion process (with 15 sec direct immersion time) with subsequent evaporation time of up to 30 sec at room temperature, followed by forced drying in a forced-air oven conditioned for example at 140° C. In order to raise the output by increasing the strip transit rate, the aqueous formulation was applied with a temperature of 90° C.

In the case of the second variant, application took place in a one-step process by application via a roller stand configured for roller coating with a contact time of 4-11 sec. Immediately thereafter the flat steel product was dried by an evaporation zone followed directly by a heating section with heated 90+/−10° C. hot air over 4-10 sec.

As a further alternative, drying may take place, alone or in combination with the air drying, by means of IR drying assistance. It is of course equally possible for the second alternative above to take place not in continuous transit, but instead sequentially—in other words, for example, in two application steps each in a roller stand process with drying in between at, for example, 90° C. over 10-15 sec. In that case the silane add-on is applied separately in a second step.

The alternative coating processes elucidated above result in determinable near-surface Zr add-ons of 1-30 mg/m² and also in measurable Si add-ons, resulting from the components, of 5-500 mg/m².

If separate protection of the flat steel product from corrosive attack during its transport to the end user is desired, it may for that purpose be covered in a manner known per se with a noncorrosive protective oil or with a forming assistant in an add-on, based on the total surface area, of approximately 1.2 g/m², for example.

Lastly, the resulting flat steel product was wound into a coil and made storable in a way which is also known per se.

1-15. (canceled)

16. A flat product comprising:
a core layer comprising a metal material; and
a coating system applied to the core layer, the coating system comprising:
a conversion layer with inorganic constituents that enhance adhesion of an outer layer to the core layer, the outer layer comprising a polymer, and
an adhesion promoter comprising an organosilane, the adhesion promoter shielding the inorganic constituents of the conversion layer.

17. The flat product of claim 16 wherein the core layer comprises a steel material.

18. The flat product of claim 16 further comprising a metallic protective coating disposed between the coating system and the core layer, wherein the metallic protective coating supports the coating system and protects the core layer against corrosion.

19. The flat product of claim 16 wherein the conversion layer comprises zirconium dioxide or titanium dioxide as the inorganic constituents that enhance adhesion of the outer layer to the core layer.

20. The flat product of claim 16 wherein the conversion layer and the adhesion promoter have a combined thickness of 20-200 nanometers.

21. The flat product of claim 16 wherein the organosilane of the adhesion promoter includes 1-40 carbon atoms.

22. A process for coating a flat product that comprises a core layer made of a metal material, a metallic protective coating that is disposed on the core layer and protects the core layer from corrosion, a coating system including a conversion layer having inorganic constituents that enhance adhesion of an outer layer including a polymer to the core layer, the process comprising:
cleaning the flat product with an alkaline cleaner;
rinsing the cleaned flat product with demineralized water;
drying the rinsed flat product;
applying to the flat product a conversion solution that comprises in an aqueous solution a zirconium compound or a titanium compound that dissociates into zirconium- or titanium fluoro complexes so as to form a conversion layer, wherein either
an organosilane that comprises an epoxy group and is water-soluble is added as an adhesion promoter, or
the flat product is rinsed with demineralized water or service water after applying the conversion solution to the flat product, then an aqueous solution of an organosilane that comprises an epoxy group is applied as an adhesion promoter; and
drying the flat product.

23. The process of claim 22 wherein the conversion solution applied comprises 10⁻⁵-10⁻¹ mol/l of the zirconium compound or the titanium compound.

24. The process of claim 22 wherein the conversion solution comprises a layer formation accelerator.

25. The process of claim 24 wherein the layer formation accelerator is water-soluble silver salt, copper salt, or iron salt.

26. The process of claim 24 wherein the conversion solution comprises 10⁻⁶-10⁻¹ mol/l of the layer formation accelerator.

27. The process of claim 22 wherein the conversion solution comprises an organosilane content of 0.45-5% by weight.

28. The process of claim 22 wherein the drying is performed in a stream of nitrogen or a stream of air.

29. The process of claim 22 wherein the drying is performed out at 40-150 degrees Celsius.

30. The process of claim 22 wherein applying the conversion solution comprises immersing the flat product for 10-300 seconds in the conversion solution.

31. The process of claim 22 wherein a pH of the conversion solution is 3-5.
